(19) United States
(12) Patent Application Publication
(10) Pub. No.: US 2012/0122386 A1
(43) Pub. Date: May 17, 2012

(54) METHOD FOR CONTROLLING AN EXTRACTOR HOOD

(75) Inventor: Volkmar Uebele, Bad Nauheim (DE)

(73) Assignee: BSH BOSCH UND SIEMENS HAUSGERATE GMBH, Munich (DE)

(21) Appl. No.: 13/277,362

(22) Filed: Oct. 20, 2011

(30) Foreign Application Priority Data
Nov. 11, 2010 (DE) 10 2010 043 757.3

(51) Int. Cl. B08B 15/02; F24F 7/00

(52) U.S. Cl. 454/67

(57) ABSTRACT

In a method for controlling an extractor hood, the power draw of a fan of the extractor hood is regulated as a function of the operating status of a heating system and/or air conditioning system. The power draw of the fan is reduced when the heating system and/or air conditioning system heats or cools the room in which the extractor hood is located. The power draw of the fan can additionally be regulated as a function of a signal relating to the current status of a power supply network.

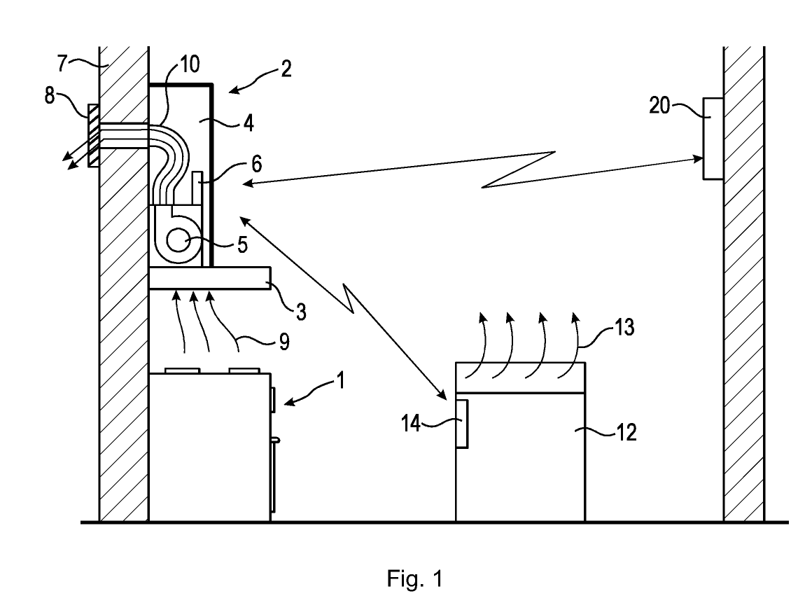

### BACKGROUND OF THE INVENTION

The invention relates to a method for controlling an extractor hood and to a control device for performing the method.

Extractor hoods are installed in kitchens in the neighborhood of a cooking zone. Vapors produced during a cooking operation can be evacuated from the neighborhood of the cooking zone by means of the extractor hood. The vapor then flows initially through a grease filter arranged in the region of the air inlet of the extractor hood. If the extractor hood is operated in the air-extraction mode of operation, the extractor hood conveys the vapor and the ambient air aspirated along with the vapor out of the kitchen and into the open air. If the extractor hood is operated in the air-recirculation mode of operation, the vapor and the ambient air aspirated along with the vapor flow through an odor filter and are then discharged back into the kitchen.

In the context of the present patent application the term extractor hood encompasses all types of household kitchen extractors, in particular also chimney cooker hoods and cooktop extractor systems.

Electrical energy consumption is an important differentiating feature for household electrical appliances such as e.g. washing machines, dishwashers, refrigerators, cookers and also extractor hoods, as well as an important selling point. To determine the energy consumption of the household appliance, the electrical power draw of the appliance is measured during certain typical usage cycles.

The power consumption of household appliances can be reduced for example through the use of energy-efficient electrical and electronic components. In the case of extractor hoods, for example, the use of particularly economical electric motors for driving the fan of the extractor hood comes into consideration for this purpose, as does the use of electronic circuits having particularly low standby consumption.

### BRIEF SUMMARY OF THE INVENTION

It is an object of the present invention to achieve a further reduction in the energy consumption arising in connection with the use of extractor hoods.

With regard to the method for controlling an extractor hood, this object is achieved according to the invention in that the power draw of a fan of the extractor hood is regulated as a function of the operating status of a heating system or air conditioning system. By “power draw of the fan” in this context is to be understood the electrical power consumption of an electric drive motor for a fan impeller that is associated with the fan. The heating system and/or air conditioning system is a device that is independent of the extractor hood and serves for heating or cooling the ambient air of the same room from which the extractor hood evacuates the vapor. An air conditioning system can be a permanently installed facility or a freestanding device. The air conditioning system serves primarily to cool the ambient air in the room. Usually it is possible to operate an air conditioning system in a heating mode, such that the air conditioning system can also be used for heating the ambient air. If a separate heating system is provided, this can likewise be part of the building installation or be in the form of at least one freestanding heating appliance.

Heating systems and/or air conditioning systems consume a considerable amount of energy in order to heat or cool the ambient air. If in that case some of said ambient air being maintained at a specific temperature is ducted out of the room by means of the extractor hood, the energy consumption of the heating system and/or air conditioning system will increase, because the replenishing air now flowing into the room must be brought to the appropriate temperature. This energy consumption of the heating system and/or air conditioning system caused by the extractor hood is referred to in the following as the secondary energy consumption of the extractor hood. In contrast, the electric power consumption of the fan of the extractor hood is the primary energy consumption of the extractor hood. In particular when there is a great difference between the temperature of the ambient air in the room and the outside temperature, the secondary energy consumption of the extractor hood can be substantially greater than the primary energy consumption.

In order to reduce the secondary energy consumption of the extractor hood, it is proposed according to the invention to regulate the power draw of the fan of the extractor hood as a function of the operating status of the heating system and/or air conditioning system. In particular the amount of ambient air discharged to the atmosphere per time unit can be reduced in this case, and moreover precisely when the heating system and/or air conditioning system is in operation.

Toward that end the power draw of the fan is reduced when the heating system and/or air conditioning system are heating or cooling the room in which the extractor hood is located. In order to achieve this, the heating system and/or air conditioning system on the one hand and the extractor hood on the other hand have a communication device. The power draw and hence the air displacement volume of the fan are reduced when the heating system and/or air conditioning system are/is in operation.

Particularly advantageously, the power draw of the fan is reduced as a function of the electrical power draw of the heating system and/or air conditioning system. In this case the power draw of the fan can also be reduced in stages, in fine increments or else in an infinitely variable manner. In this embodiment the electrical power draw of the heating system and/or air conditioning system is used exclusively as the criterion for reducing the power to the fan. Other energy sources, such as can be used for example in a heating system when fuels are combusted, are omitted from consideration. This embodiment of the invention takes into account the actual electrical energy consumption of the heating system and/or air conditioning system, which energy consumption is dependent, among other factors, also on the outside temperature and on the room temperature that has been set.

The power draw of the fan can be reduced in stages or in an infinitely variable manner. In this way the fan's performance can be individually tailored to the operating situation of the heating system and/or air conditioning system. The reduction in the power draw of the fan will be all the greater, the higher the power level of the heating system and/or air conditioning system is at the present time. It is assumed in this case that a high power level of the heating system and/or air conditioning system causes a high secondary energy consumption of the extractor hood when the latter discharges the ambient air at room temperature to the atmosphere.

A particularly advantageous method for controlling an extractor hood is present when the power draw of the fan is reduced when, and only when, the extractor hood is being operated in the air-extraction mode of operation. The extractor hood conveys ambient air from the room outside into the open air only in the air-extraction mode of operation, thus generating a secondary energy requirement. When the extractor hood is used in the air-recirculation mode of operation, on the other hand, there is no secondary energy requirement and no adjustment of the power draw of the fan is necessary.

According to a beneficial development of the invention, the power draw of the fan is regulated in addition as a function of a signal relating to the current status of the power supply network. In this case information concerning the status of the power supply network, for example an electricity tariff that is particularly favorable at the present time or a current bottleneck in supplying electrical energy, is fed back to the electrical terminal devices, in the present case to the extractor hood. Such a function is generally referred to as a “smart grid”.

It is advantageous if the power draw of the fan is reduced as a function of a signal relating to the current status of the power supply network only when the heating system and/or air conditioning system are/is simultaneously heating or cooling the room in which the extractor hood is located. If the heating system and the air conditioning system are not in operation, the full performance of the extractor hood is thus available. If, as a result of the extractor hood and the heating and/or air conditioning system being in operation simultaneously, operation of the extractor hood would bring about a particularly high consumption of electrical energy, the power draw of the fan is nonetheless reduced.

It is beneficial if the power draw of the fan is reduced as a function of a signal relating to the current status of the power supply network when the signal indicates a high level of utilization of the power supply network and/or a high electricity tariff at the present time.

With regard to a control device for an extractor hood, the object addressed in the introduction is achieved by means of a control device for performing the above-described method.

Preferably the control device has at least one communication interface for communicating with an electronic electricity meter and/or with a heating system and/or with an air conditioning system. The communication interface can be, for example, a wireless communication device, a device for transmitting data via the power grid or a device for transmitting data via a separate data line.

### DETAILED DESCRIPTION OF EXEMPLARY EMBODIMENTS OF THE PRESENT INVENTION

Further advantages and details of the invention are explained in more detail with reference to the exemplary embodiment illustrated in the schematic FIGURE.

The figure shows a kitchen with a cooking zone 1. The cooking zone 1 is defined by a cooker comprising a cooktop and an oven. Arranged above the cooking zone 1 is an extractor hood 2 which in the present exemplary embodiment is formed by a wall-mounted chimney hood. The extractor hood 2 comprises a vapor shield 3 on which a chimney 4 is mounted. Contained in the vapor shield 3 is a grease filter (not shown) for separating the grease components from the vapor. Arranged in the chimney 4 is a fan 5 by means of which the vapor 9 is drawn in below the vapor shield 3 and blown out via an exhaust air hose 10 through a wall box 8 arranged in an external wall 7 of the kitchen into the open air. The extractor hood is thus set up for use in the air-extraction mode of operation. Also arranged in the chimney 4 is a control device 6 for the extractor hood.

The kitchen also contains an air conditioning system 12, which in the present exemplary embodiment is formed by a freestanding air conditioning unit. The air conditioning system 12 draws in air from the kitchen and blows it out again into the kitchen as a cooled air stream 13. Both the extractor hood 2 and the air conditioning system 12 are supplied with electrical energy via an electronic electricity meter 20.

During its operation the extractor hood 2 causes both primary and secondary energy consumption. Primary energy consumption describes the power consumption of the extractor hood 2 itself. This is substantially determined by the power level of the fan 5 of the air conditioning system. Secondary energy consumption arises due to the fact that the extractor hood 2 conveys cooled ambient air out of the kitchen into the open air. A corresponding volume of replenishing uncooled air flows through any openings in the kitchen, through door and window gaps for example, into the kitchen. This air volume is subsequently cooled down by the air conditioning system 12 using electrical energy. The electrical energy consumed in the process by the air conditioning system 12 is referred to as the secondary energy consumption of the extractor hood 2.

Said secondary energy consumption is minimized by means of the present invention. Toward that end, the air conditioning system 12 has a communication interface 14 via which the control device 6 of the extractor hood 2 receives information relating to the current operating status of the air conditioning system 12. The control device 6 is implemented in such a way that when the air conditioning system 12 is in operation the power draw of the fan 5 of the extractor hood 2 is reduced to a value that is lower than a maximum value. The extractor hood 2 can therefore be operated while the air conditioning system is switched on, though not at full power. This results in the primary energy consumption, but in particular also the secondary energy consumption, of the extractor hood being reduced.

According to a development of the invention, the control device 6 of the extractor hood also processes a signal of an intelligent electricity meter 20 in addition. The intelligent electricity meter 20 supplies the controller 6 of the extractor hood 2 with information relating for example to the latest electricity rates or to bottlenecks currently affecting the supply of electricity in the power grid. The control device 6 can process this information in addition to the information relating to the operating status of the air conditioning system 12. The algorithm for processing the information relating to the power grid and to the air conditioning system 12 can be freely programmed or can be permanently preset. It is conceivable for example that the power draw of the fan 5 of the extractor hood 2 is regulated whenever either the air conditioning system 12 is in operation or the intelligent electricity meter 20 signals a high level of utilization of the grid's capacity. It is likewise conceivable that an adjustment of the maximum power of the fan 5 of the extractor hood 2 will be made only when a high level of utilization of the grid's capacity is signaled and simultaneously the air conditioning system 12 is in operation. It is also possible to evaluate and process the two input variables using arbitrarily programmable algorithms or a characteristic diagram.

What is claimed is:

1. A method for controlling an extractor hood, comprising regulating a power draw of a fan of the extractor hood as a function of an operating status of at least one member selected from the group consisting of heating system and conditioning system.

2. The method of claim 1, wherein the power draw of the fan is reduced when the member adjusts a temperature in a room in which the extractor hood is located.

3. The method of claim 1, wherein the power draw of the fan is reduced as a function of a current power level of the member.

4. The method of claim 1, wherein the power draw of the fan is reduced as a function of an electrical power draw of the member.

5. The method of claim 1, wherein the power draw of the fan is reduced in stages.

6. The method of claim 1, wherein the power draw of the fan is reduced in an infinitely variable manner.

7. The method of claim 1, wherein the power draw of the fan is reduced only when the extractor hood operates in an air-extraction mode of operation.

8. The method of claim 1, wherein the power draw of the fan is regulated in addition as a function of a signal relating to a current status of a power supply network.

9. The method of claim 8, wherein the power draw of the fan is reduced as a function of a signal relating to the current status of the power supply network only when the member simultaneously adjusts a temperature in a room in which the extractor hood is located.

10. The method of claim 8, wherein the power draw of the fan is reduced as a function of a signal relating to the current status of the power supply network when the signal indicates a high level of utilization of the power supply network and/or a high electricity tariff at the present time.

11. A control device for an extractor hood, configured for performing a method as claimed in claim 1.

12. The control device of claim 11, said control device comprising at least one communication interface for communicating with at least one member selected from the group consisting of an electronic electricity meter, a heating system, and an air conditioning system.

13. The control device of claim 11, said control device being constructed to reduce a power draw of a fan of the extractor hood when at least one member selected from the group consisting of heating system, and air conditioning system adjusts a temperature in a room in which the extractor hood is located.

14. The control device of claim 13, said control device being constructed to reduce the power draw of the fan as a function of a current power level of the member.

15. The control device of claim 13, said control device being constructed to reduce the power draw of the fan as a function of an electrical power draw of the member.

16. The control device of claim 13, said control device being constructed to reduce the power draw of the fan in stages.

17. The control device of claim 13, said control device being constructed to reduce the power draw of the fan in an infinitely variable manner.

18. The control device of claim 13, said control device being constructed to reduce the power draw of the fan only when the extractor hood operates in an air-extraction mode of operation.

19. The control device of claim 13, said control device being constructed to regulate the power draw of the fan in addition as a function of a signal relating to a current status of a power supply network.

20. The control device of claim 19, said control device being constructed to reduce the power draw of the fan as a function of a signal relating to the current status of the power supply network only when the member simultaneously adjusts a temperature in a room in which the extractor hood is located.

21. The control device of claim 19, said control device being constructed to reduce a power draw of the fan as a function of a signal relating to the current status of the power supply network when the signal indicates a high level of utilization of the power supply network and/or a high electricity tariff at the present time.

22. A control device for controlling operation of an extractor hood, said control device being constructed to receive information from a communication interface about a current operating status of a member selected from the group consisting of heating system and air conditioning system, and to regulate a power draw of a fan of the extractor hood as a function of an operating status of the member.

23. The control device of claim 22, said control device being constructed to reduce the power draw of the fan of the extractor hood during operation of the member.

24. The control device of claim 22, said control device being constructed to receive information of an electricity meter about a current electricity tariff for regulating the power draw of the fan.
